(19) United States
(12) Patent Application Publication
(10) Pub. No.: US 2013/0226799 A1
(43) Pub. Date: Aug. 29, 2013

(54) AUTHENTICATION PROCESS FOR VALUE TRANSFER MACHINE

(71) Applicant: Thanigaivel Ashwin Raj, Foster City, CA (US)

(72) Inventor: Thanigaivel Ashwin Raj, Foster City, CA (US)

(21) Appl. No.: 13/593,245

(22) Filed: Aug. 23, 2012

Related U.S. Application Data
(60) Provisional application No. 61/526,555, filed on Aug. 23, 2011.
(60) Provisional application No. 61/615,550, filed on Mar. 26, 2012.

(51) Int. Cl. G06Q 20/38

(52) U.S. Cl. CPC G06Q 20/3821
USPC 705/44

(57) ABSTRACT

Embodiments of the invention are directed towards improved transaction processing methods and systems with transaction apparatuses, including a value transfer machine, using a device identifier instead of a value transfer machine card to process a transaction. One embodiment of the transaction may be directed to a transaction apparatus and a method including receiving an authentication code from a consumer, sending the authentication code to a first server computer, wherein if the received authentication code matches a generated authentication code, the first server sends a confirmation message. The method continues by receiving the confirmation message from the first server, receiving a secret token from the consumer, and sending an authorization request message to a second server computer. Thereafter, the transaction apparatus receives an authorization response message from the second server, indicating whether the secret token matches an expected token. Other embodiments are directed to first and second servers and corresponding methods.

### CROSS-REFERENCES TO RELATED APPLICATIONS

This application is related to U.S. Provisional Application No. 61/526,555, filed on Aug. 23, 2011, and U.S. Provisional Application No. 61/615,550, filed on Mar. 26, 2012, which are both hereby incorporated by reference in their entirety for all purposes.

### BACKGROUND

Many financial transactions are conducted with portable consumer devices, such as credit cards, debit cards, or ATM/bank cards. For example, when a consumer wishes to withdraw cash from a value transfer machine, such as an Automatic Teller Machine (ATM), the consumer must use an ATM or bank card, or a credit card enabled to withdraw cash. Carrying multiple portable consumer devices (e.g., credit cards, debit cards, ATM cards) can be cumbersome. Also, it can be difficult for the consumer to keep track of all the different portable consumer devices and the consumer may forget to bring a specific portable consumer device for a specific transaction, such as withdrawing cash. Having multiple portable consumer devices also makes them prone to loss or theft.

ATM cards are particularly vulnerable to loss or theft because they are directly associated to the consumer's Personal Account Number (PAN) at an issuer (e.g., bank). Although typically a secret token (Personal Identification Number) is needed in conjunction with the ATM card, the secret token is static and can still be compromised if the ATM card has been stolen. It would be advantageous to provide another layer of security in authenticating transactions at ATMs and consolidate the number of portable consumer devices.

Additionally, some consumers may not have bank accounts at typical account issuers, and thus may not have a corresponding portable consumer device, but may find it beneficial to have access to funds from value transfer machines. Accordingly, it would be advantageous to allow a consumer to access funds from a value transfer machine or other transaction apparatus without requiring a typical portable consumer device to be presented during a transaction.

Embodiments of the invention address this and other problems.

### BRIEF SUMMARY

Embodiments of the invention are directed towards improved transaction processing with a transaction apparatus including a value transfer machine using a device identifier of a consumer instead of a value transfer machine card used in typical transactions.

One embodiment of the transaction may be directed to a transaction apparatus comprising a processor and a computer-readable storage medium. The computer-readable storage medium may comprise code executable by the processor to implement a method including receiving an authentication code from a consumer and sending the authentication code to a first server computer, wherein if the received authentication code matches a generated authentication code, the first server sends a confirmation message. The method continues by receiving the confirmation message from the first server computer, receiving a secret token from the consumer, and sending an authorization request message to a second server computer. Thereafter, the transaction apparatus receives an authorization response message from the second server computer, wherein the authorization response message indicates that the secret token matches an expected token and completes the transaction.

Another embodiment of the transaction may be directed to a method comprising receiving an authentication code from a consumer and sending the authentication code to a first server computer, wherein if the received authentication code matches a generated authentication code, the first server sends a confirmation message. The method continues by receiving the confirmation message from the first server computer, receiving a secret token from the consumer, and sending an authorization request message to a second server computer. Thereafter, the transaction apparatus receives an authorization response message from the second server computer, wherein the authorization response message indicates that the secret token matches an expected token and completes the transaction.

Another embodiment of the transaction may be directed to a first server computer comprising a processor and a computer-readable storage medium. The computer-readable storage medium may comprise code executable by the processor to implement a method. The method comprising electronically receiving a device identifier, generating an authentication code for a transaction, and electronically transmitting the generated authentication code to a device associated with the device identifier. Thereafter the method continues by electronically receiving a received authentication code from a transaction apparatus, matching the received authentication code with the generated authentication code for the transaction, and sending a confirmation message to the transaction apparatus.

Another embodiment of the present invention is directed to a method comprising electronically receiving a device identifier, generating an authentication code for a transaction, and electronically transmitting the generated authentication code to a device associated with the device identifier. Thereafter the method continues by electronically receiving a received authentication code from a transaction apparatus, matching the received authentication code with the generated authentication code for the transaction, and sending a confirmation message to the transaction apparatus.

### BRIEF DESCRIPTION OF THE DRAWINGS

FIG. 1 illustrates a system that allows banked consumers to access funds from a value transfer machine according to embodiments of the invention.

FIG. 2 illustrates a system that allows unbanked consumers to access funds from a value transfer machine according to another embodiment of the invention.

FIG. 3 shows an exemplary payment processing network server computer according to embodiments of the invention.

FIG. 4 shows a flowchart of an exemplary method for processing transactions at a value transfer machine for banked consumers without a corresponding portable consumer device according to embodiments of the invention.

FIG. 5 shows an exemplary system and method for processing transactions at a value transfer machine for banked consumers without a corresponding portable consumer device according to embodiments of the invention.

FIG. 6 shows an exemplary system and method for processing transactions at a value transfer machine for unbanked consumers according to embodiments of the invention.

FIG. 7 shows a block diagram of an exemplary computer apparatus according to an embodiment of the invention.

### DETAILED DESCRIPTION

Embodiments of the present invention are directed to transactions between consumers and transaction apparatuses. Specifically, embodiments of the present invention allow consumers to complete transactions at value transfer machines (e.g. an automated teller machine (ATM)) without the need to carry a portable consumer device associated with a payment account (i.e. ATM card). Instead, embodiments of the present invention allow consumers to use an authentication code associated with a device to complete a transaction.

For example, a consumer may wish to withdraw cash from an account at an issuing bank, transfer funds between accounts, or simply view the current status of the account. In order to save time, the consumer may wish to perform the transactions at an ATM instead of entering a bank branch. Typically, during such transactions, the consumer may be requested to swipe a value transfer machine card (e.g. an ATM card) to initiate such a transaction. Information stored on the ATM card may comprise an account identifier that informs the ATM of the issuer and account associated with the transaction. The ATM may transmit the account identifier, transaction information, and other information from the ATM card (e.g. expiration date, CVV, dCVV, etc.) to an account issuer (e.g. an issuing bank) to identify the account of the consumer so that authorization for the transaction may be provided. To access the account, the consumer may be asked to provide a secret token (e.g. a personal identification number (PIN)) to the ATM. The secret token may be a pre-determined number associated with the consumer's account that is identified by an account identifier (e.g. a personal account number (PAN)). Secret tokens are typically static and may comprise, for example, four numerical digits. The secret token may be pre-determined by the issuing bank of the account or by the consumer, and may be stored and associated to the account identifier by the issuing bank. The ATM communicates with an account issuer (e.g., the issuing bank of the account identifier) to determine if the secret token entered matches an expected token associated with the account for which the consumer wishes to use in the transaction. Only when the secret token entered matches the expected token associated with the account identifier can the consumer continue the desired transaction at the ATM.

According to embodiments of the invention, the consumer's account may be identified by a device identifier, such as a mobile device identifier, without using the ATM card. Embodiments of the present invention use an authentication code generated by a payment processing network to confirm the consumer has possession of the device associated with the device identifier. Accordingly, an authentication code may be requested by the ATM or by the device, and the mobile device identifier may be used to receive a dynamically generated authentication code for a transaction. A device identifier may be provided to a payment processing network that may determine a corresponding account identifier for the mobile device and may generate an authentication code for the transaction. The payment processing network may send the authentication code to the device such that the consumer may receive the authentication code and confirm that they have access to the device by providing the authentication code to the ATM for comparison to the previously generated authentication code at the payment processing network. Accordingly, the dynamic authentication code may be used by the system to authenticate the consumer as having possession of the device associated with a requested account or device identifier, before allowing any transaction to be initiated.

Additionally, some embodiments of the present invention allow unbanked consumers to complete transactions with automated transaction apparatuses without being registered with a typical account issuer (i.e. bank) and thus without requiring consumers to carry an ATM card associated with a payment account. Accordingly, a consumer may use a device identifier, an authentication code, and a secret token to complete a transaction with a transaction apparatus without the use of a portable consumer device (e.g. an ATM or debit card) tied to a typical bank account (e.g. a debit account). For example, a consumer could use their device identifier and authentication code to authenticate themselves to an ATM that links to an account associated with their mobile network operator. Accordingly, a payment processing network may comprise or may be coupled to a mobile payment processor that operates as a transaction processor, router, and authenticator between ATM operators and mobile network operators.

By providing a mobile payment processor between ATM operators and service providers (e.g. mobile network operators), the mobile payment processor may provide a transaction authentication and transaction processing service that provides fast, efficient, and secure transaction processing. Additionally, the mobile payment processor may be placed in a unique position to process transactions for customers of a number of different service providers. Accordingly, the mobile payment processor may comprise a vast array of information about a number of different consumers from a number of different service providers and may be able to efficiently process transactions for any number of operators. Accordingly, consumers receive the advantage of fast, efficient, and effective access to cash from a number of different transaction apparatuses, service providers receive the advantage of not having to store additional information about their consumers and undergo infrastructure upgrades to process such transactions, and ATM operators receive the benefit of an increased number of customers.

Prior to discussing the specific embodiments of the invention, a further description of some terms can be provided for a better understanding of embodiments of the invention.

A “device identifier” may include any unique information associated with an electronic device. The device identifier may be associated with the device itself, a component of the device (e.g. a SIM card), or with a network operator providing wireless communications services to an electronic device. For example, the device identifier may be a phone number for a cellular mobile telephone that is associated with a consumer account with a mobile network operator. Alternatively, the device identifier may be a predetermined collection of symbols, numbers, alphanumeric characters, etc. that may be assigned to a particular consumer device during a registration period. Furthermore, the device identifier may be provided by a device manufacturer, for example, a serial number or other similar information provided during manufacture of the device. The device identifier may be used to communicate with the device either by using the device identifier (e.g. a phone number is the device identifier and is used to contact the device) or the device identifier may be used to determine contact information stored on a database (e.g. a device database comprises device identifiers and corresponding phone numbers and account identifiers).

An “authentication code” may include any verifiable and reproducible information that may be used to authenticate a consumer. For example, the authentication code may comprise a collection of letters, numbers, and symbols. The authentication code may be recognizable to a human (e.g. a name, address, or phone number) or an unrecognizable collection of symbols (e.g. 4839060, r83kf, or fjdskfo). The authentication code may be any length and may comprise a sequence of letters, numbers, or a combination of both. The sequence of letters, numbers, and symbols may comprise common and generally available characters that may be found on a number of different input devices (e.g. keyboards, touch screens, etc.) of transaction apparatuses so that the authentication code may be entered on a wide range of transaction apparatuses. The authentication code may be dynamic, unique to every transaction, randomly generated, or generated using a pre-determined algorithm. Furthermore, the authentication code may be generated based on a received device identifier for a transaction, an account identifier, other transaction information, or may be generated randomly. Furthermore, the authentication code may be temporary such that the effectiveness of the authentication may be for a predetermined period of time, predetermined number of transactions, or the authentication code may only be stored for a temporary amount of time.

In some embodiments, an authentication code may be generated by a payment processing network, a copy of the authentication code may be sent to an electronic device associated with a consumer, the consumer may provide the authentication code to a transaction apparatus, and the ATM may send the authentication code to the payment processing network for comparison to the originally generated authentication code. If the authentication code received at the payment processing network from the transaction apparatus matches the originally generated authentication code, then the payment processing network may send a confirmation message to the transaction apparatus indicating that the consumer is in possession of the device associated with the device identifier.

A “confirmation message” may include any message that confirms or verifies the authentication of an authentication code. The confirmation message may include an indication that a particular consumer is authenticated or may include an indication that a received authentication code matches a previously generated authentication code. For example, the confirmation message may comprise a flag informing a system of whether a received authentication code matches a previously generated authentication code. Additionally, the confirmation message may further comprise information related to the authentication code, device identifier, consumer, or previous confirmation request received by the payment processing network. For example, the confirmation message may comprise an account identifier associated with the authentication code. The exemplary confirmation message may also include an indication of whether the authentication code matches the previously generated authentication code or the account identifier may be the indication of whether the authentication code matches. The confirmation message may be sent from a payment processing network or other third party authentication entity in communication with a transaction apparatus or value transfer machine.

A “secret token” may include any reproducible information associated with an account of a consumer that is known to the consumer and system and is secured by the system. For example, a secret token may be a personal identification number (PIN), personal password, or other secret information that may be established during registration with the issuer of an account. The secret token may be provided by a consumer or may be provided by an issuer, mobile network operator, or other service provider. For example, when opening an account with an account issuer, the account issuer may ask the consumer for a secret token (e.g. the last four digits of their social security number) to be used during any transactions or may ask for separate secret tokens for each type of transaction. Alternatively, the issuer may provide the consumer with a predetermined secret token (e.g. a randomly generated four digit code) that the consumer may be asked to provide during any ATM transaction or other transaction in the future. The mobile network operator, issuer, or other system issuing the secret token may secure the secret token such that the secret token may be encrypted while being stored or transmitted so that a malicious third party may not gain access to the secret token if the secret token is intercepted during a transaction or a system storing a secret token or expected token is compromised. Accordingly, the secret token may be encrypted using any suitable encryption technique. Because the secret token is only known to the consumer and the issuer, the secret token may be used during a transaction to authenticate the consumer. Accordingly, the secret token may be sent within an authorization request message and verified by an issuer or mobile payment processor prior to authorizing a transaction.

An “expected token” may include a stored version of the secret token located at the verifying entity. The expected token may be stored at an issuer associated with an account being used during a transaction, a mobile payment processor, a mobile network operator, or any other entity that is authorizing or verifying the identity of a consumer prior to a transaction being authorized. If a secret token received by such an entity is compared to the expected token stored at the entity, and the secret token and the expected token match, the entity may know that the presenter initiating the transaction is the consumer associated with the account or an entity authorized by the consumer to use the account. Accordingly, the issuer, mobile payment processor, or other entity may authorize the transaction by sending an authorization response message that indicates that the secret token matches an expected token and that the transaction may be completed by the transaction apparatus.

An “account identifier” may include any unique, reproducible information that is associated with an account at an account issuer. For example, the account identifier may be a primary account number (PAN), a credit card or debit card number, unique personal identification information that identifies the consumer to an issuer (e.g. social security number, phone number, name, etc.), or any other information that may identify an account at an issuer. In some embodiments, the account identifier may comprise the device identifier corresponding to a consumer's electronic device. Additionally, the account identifier may comprise a bank identification number (BIN) or other routing information that informs a transaction processing system where an authorization request message should be routed in order to receive authorization for a transaction from an associated issuer for an account.

An “authorization request message” may be an electronic message that is sent to a payment processing network and/or an issuer of a payment card to request authorization for a transaction. An authorization request message according to some embodiments may comply with ISO 8583, which is a standard for systems that exchange electronic transaction information associated with a payment made by a consumer using a payment device or payment account. The authorization request message may include an issuer account identifier that may be associated with a payment device or payment account and a secret token provided by a consumer. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, ATM identifier, ATM location, etc., as well as any other information that may be utilized in determining whether to identify and/or authorize a transaction.

An “authorization response message” may be an electronic message reply to an authorization request message generated by an account issuer, payment processing network, mobile payment processor, or a mobile network operator. The authorization response message may include, by way of example only, one or more of the following status indicators: Approval—transaction was approved; Decline—transaction was not approved; or Call Center—response pending more information, may call the toll-free authorization phone number. The authorization response message may also include an authorization code, which may be a code that an issuing bank or other entity (e.g. a mobile network operator or mobile payment processor) returns in response to an authorization request message in an electronic message (either directly or through the payment processing network) to the transaction apparatus (e.g. value transfer machine) that indicates approval of the transaction and completes the transaction. The code may serve as proof of authorization. As noted above, in some embodiments, a payment processing network may generate or forward the authorization response message to the transaction apparatus.

A “device” may be in any suitable form. For example, suitable devices can be hand-held, compact, and mobile so that a consumer can easily carry the device at all times in the consumer's pocket or purse. Examples of devices include computers, cellular phones, PDAs, personal computers (PCs), tablets, and the like. As used herein, a “mobile device” may comprise any electronic device that may be transported and operated by a consumer, which may also provide remote communication capabilities to a network. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, personal music players, hand-held specialized readers, etc. A mobile device may comprise any suitable hardware and software for performing such functions, and may also include multiple devices or components (e.g. when a device has remote access to a network by tethering to another device—i.e. using the other device as a modem—both devices taken together may be considered a single mobile device). A mobile device may also comprise a verification token in the form of, for instance, a secured hardware or software component within the mobile device and/or one or more external components that may be coupled to the mobile device.

As used herein, “transaction information” may refer to any suitable information associated with a financial transaction, such as a transaction amount, an ATM identifier for an ATM or ATM operator associated with the transaction, the volume of the transaction, information about the goods or services being purchased, the ATM location, and any other information that is related to the current transaction.

A “transaction apparatus” may include any apparatus that initiates and completes a transaction. For example, the transaction apparatus may include a value transfer machine. A “value transfer machine” may include any transaction apparatus that allows a consumer to transfer funds between accounts, withdraw funds from an account, deposit funds into an account, etc. For example, a value transfer machine includes an ATM machine. In some embodiments, the transactions apparatuses may be automated transaction apparatuses. For example, automated teller machines (ATMs) and vending machines are examples of automated transactions apparatuses.

A “portable consumer device” may be in any suitable form. For example, suitable portable consumer devices can be hand-held and compact so that they can fit into a consumer's wallet and/or pocket (e.g., pocket-sized). They may include smart cards, credit or debit cards (with a magnetic stripe), keychain devices (such as the Speedpass™ commercially available from Exxon-Mobil Corp.), etc. Other examples of portable consumer devices include cellular phones, personal digital assistants (PDAs), pagers, payment cards, security cards, access cards, smart media, transponders, and the like. The portable consumer devices can also be debit devices (e.g., a debit card), credit devices (e.g., a credit card), or stored value devices (e.g., a stored value card).

As used herein, a “banked consumer” may indicate that a consumer has an account at an account issuer. For example, a banked consumer may be a consumer that has opened a debit account at a bank and has an ATM card linked to their debit account. Accordingly, the banked consumer may perform a transaction by providing sufficient information to identify an account (e.g. the debit account) at the account issuer (i.e. bank) and provide authentication information such that the account issuer knows the transaction is not fraudulent.

As used herein, an “unbanked consumer” may include a consumer that does not have an account at an account issuer. For example, it may be common for consumers in third world countries or rural areas to not have an account at a bank because there are no banks within their immediate geographical area or they do not have sufficient funds or access to justify having an account. However, unbanked consumers may have accounts at service providers such as mobile network operators, utilities, and/or land managers (hotels, landlords, etc.). Accordingly, in some embodiments, these pre-existing accounts at service providers may be used to perform transactions for the unbanked consumer at transaction apparatuses.

For example, an unbanked consumer may have a mobile payment account linked to a mobile telephone account with a mobile network operator. As such, the unbanked consumer may use the mobile telephone account to perform an ATM transaction with the payment being authorized, cleared, and/or settled using the account with the mobile network operator. Because mobile network operators are not sophisticated transaction processors, and so that they may focus on improving mobile network operation instead of processing financial transactions, a mobile payment processor may facilitate the transaction between the ATM operators and the mobile network operators. Accordingly, unbanked consumers may perform financial transactions with transaction apparatuses including value transfer machines according to embodiments of the present invention without having a typical account at an account issuer.

A “payment processing network” may include data processing subsystems, networks, and operations used to support and deliver authorization services, exception file services, and clearing and settlement services. An exemplary payment processing system may include VisaNet™. Payment processing systems such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network may use any suitable wired or wireless network, including the Internet.

As used herein, an “issuer” may typically refer to a business entity (e.g., a bank or other financial institution) that maintains financial accounts for the consumer and often issues a portable consumer device such as a credit or debit card to the consumer.

A “mobile payment processor” may include a specialized part of the payment processing network or may be independent from the payment processing network but may communicate with the payment processing network. The mobile payment processor includes a specialized processing entity that facilitates the processing of transactions for unbanked consumers using the account associated with a service provided by an entity that is not a bank. For example, a mobile payment processor may facilitate transactions between the ATM operator (e.g. a bank, regional ATM processing network, ATM owner) and a mobile network operator (e.g. Verizon™, ATT™, etc.). The mobile payment processor may comprise the same components as the payment processing network described above and in further detail below.

A “server computer” can be a powerful computer or a cluster of computers. For example, the server computer can be a large mainframe, a minicomputer cluster, or a group of servers functioning as a unit. In one example, the server computer may be a database server coupled to a Web server.

### I. Exemplary Systems

Embodiments of the present invention may comprise at least two different systems, a first embodiment provides authentication and processing of transactions with transaction apparatuses (e.g. value transfer machines, vending machines, etc.) using a typical transaction processing system for banked consumers, and a second embodiment provides authentication and processing for unbanked consumers that do not have typical accounts associated with an account issuer. Although the systems are similar and some aspects overlap, the different embodiments comprise different entities performing various transaction processing steps. Both embodiments will be described in further detail below.

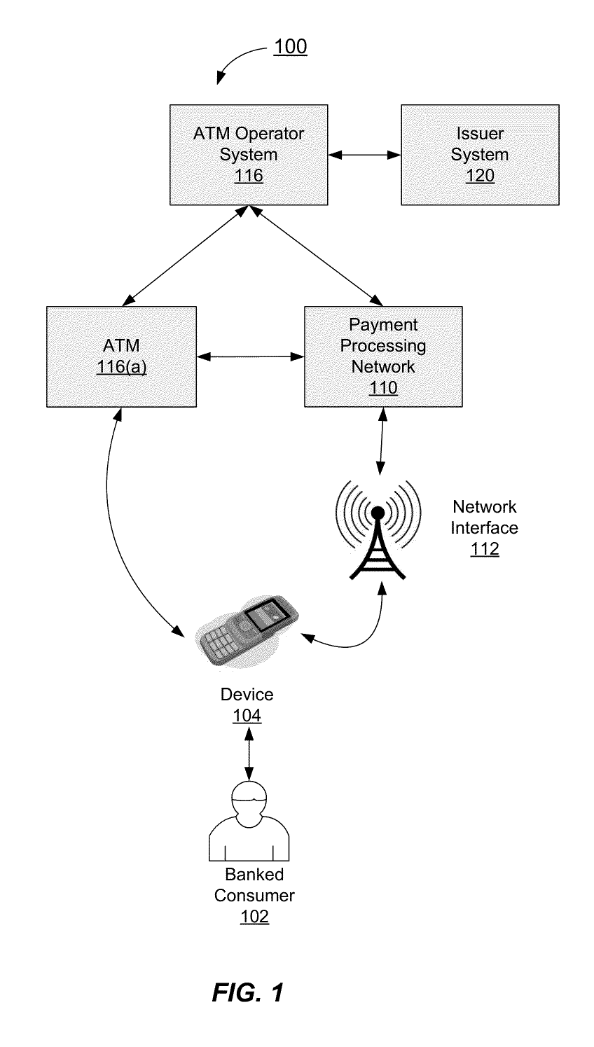

FIG. 1 illustrates a system according to a first banked consumer 102 embodiment of the invention. A banked consumer 102 may have a device 104, such as a mobile device (e.g., PDA, mobile phone), and may wish to conduct a transaction at an ATM 116(a) operated by an ATM operator 116, such as an ATM transaction processor, a bank, or a third party ATM owner/operator. To initiate the transaction, the ATM 116(a) may request the consumer 102 to provide a mobile device identifier to the ATM 116(a). The ATM 116(a) may then electronically transmit the mobile device identifier to a payment processing network 110 (e.g. VisaNet). The different entities in the system may all be in operative communication with each other (i.e. although not depicted in FIG. 1, one or more communication channels may exist between each of the entities, whether or not these channels are used in conducting a transaction).

The payment processing network 110 may comprise a routing directory module, an account database, a device identifier database, and/or any other information database such that the payment processing network 110 may determine an account identifier associated with the device identifier, may generate an authorization code that is effective for a transaction or limited time period, and may send the authentication code to the mobile device 104 associated with the device identifier. The authentication code may be dynamic, unique to every transaction, randomly generated, or generated using a pre-determined algorithm. The authentication code may be a sequence of letters, numbers, or a combination of both, and may be a set number of characters long. Exemplary authentication codes may be 4839060, r83kf, or fjdskfo.

Using a network interface 112 to a communication network, such as a telecommunications network, the payment processing network 110 may electronically transmit the generated authentication code to the mobile device 104. The consumer 102 may then be prompted by the ATM 116(a) to provide the authentication code received on the mobile device 104. Any other suitable communications network (e.g. the internet) may be used to transmit the authentication code to the mobile device 104.

The consumer 102 may provide the authentication code received on their mobile device to the ATM 116(a) through manual entry into the ATM 116(a) or in some embodiments, the mobile device 104 may transmit the authentication code through short range communications element (e.g. NFC communications element, Bluetooth™ transceivers, etc.) or through any other suitable communication means. After receiving the authentication code from the consumer 102, the ATM 116(a) electronically communicates with the payment processing network 110 to verify that the received authentication code entered by the consumer 102 matches the authentication code previously generated by the payment processing network 110. If they match, the payment processing network 110 sends a confirmation message to the ATM 116(a) that confirms that the consumer 102 is in possession of the mobile device 104 associated with the device identifier used to initiate the transaction. In some embodiments, the confirmation message may comprise the account identifier that is associated with the mobile device 104 to be used to process the ATM 116(a) transaction.

Accordingly, the account identifier has been identified without the consumer 102 presenting or using an ATM card associated with their account. The ATM 116(a) and ATM operator 116 can now continue the transaction as typically conducted, by requesting a secret token (e.g. a PIN) to access the account associated with the account identifier or in some embodiments, the mobile device identifier. The secret token may be included in an authorization request message that may be transmitted to an issuer 120 of the account and the issuer 120 may verify the secret token matches a predetermined expected token for the account identifier before a transaction is authorized. The issuer may check the account balance and make other similar verifications and may generate an authorization response message that is transmitted back to the ATM.

Accordingly, the issuer 120 may be confident that not only does the consumer 102 have possession of the mobile device 104 that is associated with the account identifier but also that the consumer is authorized to use the account associated with the mobile device 104 because the consumer has access to the correct secret token. The secret token may be secure information that only those who have authorization to use the account may know. As such, if the mobile device 104 was stolen, a fraudulent consumer 102 would still not be able to access the account because the malicious third party would not know the secret token associated with the account identifier and the transaction cannot be processed without both the authentication code and secret token being verified. Additionally, because the authorization code and the secret token are verified by two separate entities, a payment processing network 110 and an issuer 120, if one system is compromised the security of the system is still maintained.

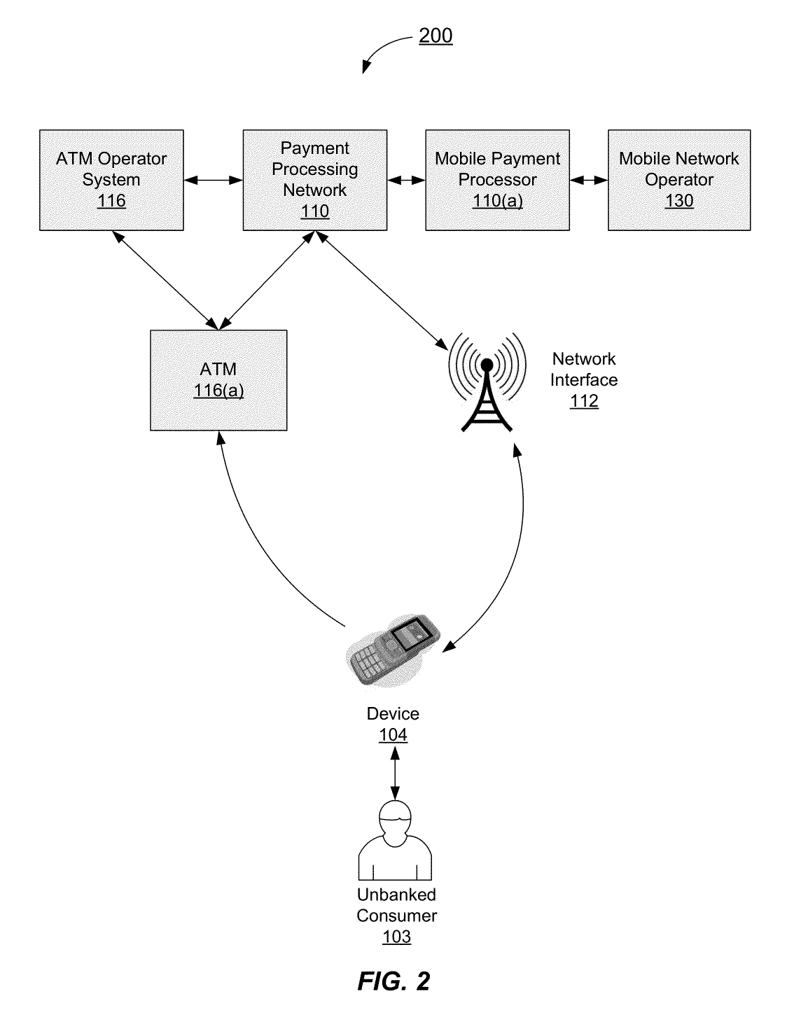

FIG. 2 illustrates a second embodiment of a transaction system configured to process transactions for unbanked consumers 103 that do not have a physical ATM card or a typical issuer account. The system of FIG. 2 is similar to the system shown in FIG. 1 but instead of sending an authorization request message to an issuer 120 through the ATM operator 116, the ATM operator 116 sends the authorization request message to a mobile payment processor 110(a) for and/or a mobile network operator 130.

Similar to the system shown in FIG. 1, an unbanked consumer 103 may have a device 104, such as a mobile device (e.g., PDA, mobile phone), and wish to conduct a transaction at an ATM 116(a) operated by an ATM operator 116, such as an ATM transaction processor, a bank, or a third party ATM owner/operator. To initiate the transaction, the ATM 116(a) may request the consumer 103 to provide the mobile device identifier to the ATM 116(a). The ATM 116(a) may then electronically transmit the mobile device identifier to a payment processing network 110 (e.g. VisaNet). Just as in the system described in FIG. 1, the payment processing network 110 may generate and transmit an authorization code to the mobile device 104. However, the payment processing network 110 may use the device identifier as the account identifier because the consumer 103 is unbanked and thus does not have an account with an account issuer 120. Alternatively, some embodiments may use an account identifier which may be generated and stored in an account database at the payment processing network 110 or mobile payment processor 110(a) during a registration process for the mobile payment service.

As with the system in FIG. 1, the payment processing network 110 may transmit the authentication code to the mobile device 104 and the consumer may provide the authentication code to the ATM 116(a). The ATM 116(a) may verify the authentication code with the payment processing network 110 and after receiving a confirmation message from the payment processing network 110, the ATM 116(a) may ask the consumer for a secret token. Additionally, in some embodiments, instead of a payment processing network 110, a mobile payment processor 110(a) may implement the authentication code process as well. However, this embodiment may not involve two separate system verifying the authentication code and the secret token so it may be preferable to keep the entities separate or have the mobile network operator 130 verify the secret token matches an expected token for the transaction. One of ordinary skill would recognize there are many different ways of implementing the present invention.

Once the consumer enters the secret token, however, the transaction processing may divert from the system in FIG. 1. As shown in FIG. 2, the ATM operator 116 may determine that the mobile device identifier may be used as the account identifier or the confirmation message may comprise a flag or other indicator that the authorization request message may be transmitted to a mobile payment processor 110(a) instead of an account issuer. For example, in the account identifier filed, a bank identification number (BIN) may be provided that identifies a payment processing network 110 or mobile payment processor 110(a) as the entity that the authorization request message may be routed to instead of a typical issuer. Additionally, the authorization request message may comprise a special field or flag that informs the ATM operator 116 that the authorization request message should be routed to the payment processing network 110 or mobile payment processor 110(a). The ATM 116(a) may know to input this flag or field into the authorization request message because the consumer selects a particular type of transaction (card-less transaction) or because the received confirmation message from the payment processing network 110 informs the ATM 116(a) to input the field or flag. Either way, the authorization request message is configured in manner such that the ATM operator 116 knows to forward the authorization request message to the payment processing network 110 or mobile payment processor 110(a).

The mobile payment processor 110(a) may be a specialized processing entity that facilitates the processing of transactions for unbanked consumers using an account associated with a service provider that is not a bank. For example, a mobile payment processor 110(a) may facilitate transactions between the ATM operator 116 (e.g. a bank, regional ATM processing network, ATM owner) and a mobile network operator 130 (e.g. Verizon™, ATT™, etc.). The mobile payment processor 110(a) may be a part of a payment processing network 110 or may be a separate independent entity. Either way, an authorization request message may be generated by the ATM 116(a) comprising the mobile device identifier or an associated account identifier that indicates that the authorization request message may be routed to the mobile payment processor 110(a). The authorization request message may comprise the device identifier, secret token, and/or account identifier.

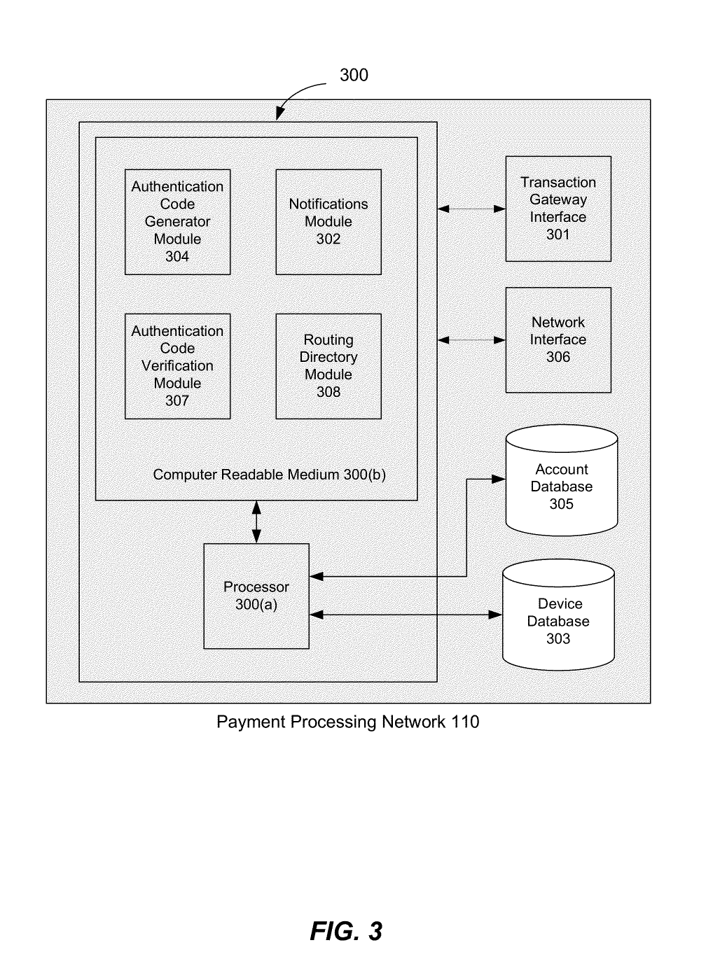

The mobile payment processor 110(a) may comprise the same components as the payment processing network shown in FIG. 3 but instead of an authentication code generator module 304 and authentication code verification module 307, the mobile payment processing module may comprise a secret token comparison module (not shown). Similarly to the payment processing network 110, the mobile payment processor 110(a) may comprise an account database, but the account database may comprise an expected token associated with the mobile device identifier and/or account identifier (if one exists). Accordingly, the mobile payment processor 110(a) may validate the secret token in the authorization request message and may indicate to a mobile network operator 130 if the secret token included in the authorization request message matches the expected token for the mobile device identifier. Accordingly, the consumer's identity may still be authenticated such that only an authorized consumer may perform a transaction using embodiments of the present invention.

If the secret token matches the expected token associated with the mobile device identifier, the mobile payment processor 110(a) may update the authorization request message to indicate that the secret token is verified and may forward the authorization request message to a mobile network operator 130. The mobile network operator 130 may ensure the account associated with the mobile device 104 is current and may authorize or deny the transaction. The mobile network operator 130 may then generate an authorization response message that may be routed back to the ATM 116(a) and the depending on whether the transaction is authorized, the ATM 116(a) may dispense the transaction amount to the consumer or may inform the consumer that the transaction was denied. The mobile payment processor 110(a) may then coordinate clearance and settlement between the mobile network operator 130 and the ATM operator 116 at a periodic time (e.g. monthly, weekly, daily, etc.) and may otherwise facilitate the settlement of all payments between the ATM operator 116 and the mobile network operator 130.

Accordingly, embodiments of the present invention may allow unbanked consumers to complete transactions with ATMs 116(a) or other transaction apparatuses without the necessity of a typical issuer or the possession of a portable consumer device 104 tied to an account of an account issuer 120.

FIG. 3 shows an exemplary payment processing network 110. The payment processing network 110 may comprise a server computer 300. The server computer 300 comprises a processor 300(a) and a computer readable medium 300(b). Although many of the data processing functions and features of some embodiments may be present in the payment processing network (and a server computer 300 therein), it should be understood that such functions and features could be present in other components such as the issuer computer 120, the mobile payment processor 110(a), or the mobile network operator 130, and need not be present in the payment processing network 110, or a server computer 300 therein.

The exemplary server computer 300 is illustrated as comprising a plurality of hardware and software modules. However, it should be appreciated that this is provided for illustration purposes only, and each of the modules and associated functionality may be provided and/or performed by the same or different components. That is, exemplary server computer 300 may, for example, perform some of the relevant functions and steps described herein with reference to the payment processing network 110 through the use of any suitable combination of software instructions and/or hardware configurations. It should be noted that although FIG. 3 illustrates all of the modules located on a single device, the disclosure is not meant to be so limited. Moreover, a system for implementing the functionality described herein may have additional components or less then all of these components. Additionally, some modules may be located on other devices such as a remote server or other local devices that are functionally connected to the server computer component(s).

The payment processing network 110 may comprise a computer readable medium 300(a) and the computer readable medium 300(b) may comprise code executable by the processor 300(a) to perform various methods and functions. The computer readable medium 300(b) may comprise software modules, such as an authentication code generator module 304 and a notifications module 302. Additionally, the payment processing network may comprise hardware modules such as a transaction gateway interface 301 and a network interface 306. The payment processing network 110 may also comprise an account database 305 and a device database 303, which are searched and queried by the processor 300(a) to identify the device identifier received by the ATM 116(a) and determine an associated account (if any).

A routing directory module 307 in the computer readable medium 300(b) may receive a device identifier from the ATM and may search the device database for the received device identifier. The routing directory module 307 may determine an account identifier associated with the device identifier in the device database. Accordingly, the routing directory module 307 may search the account database for further information related to the account identifier. In some embodiments directed to unbanked consumers 103, the routing directory module 307 may be used to determine a mobile payment processor 110(a) and mobile network operator 130 in which to route an authorization request message to. However, in the present embodiment, the routing director module 307 determines the account identifier associated with the received device identifier and may include this information in a confirmation message to be sent to the ATM once the consumer is authenticated or may use this information to generate the authentication code.

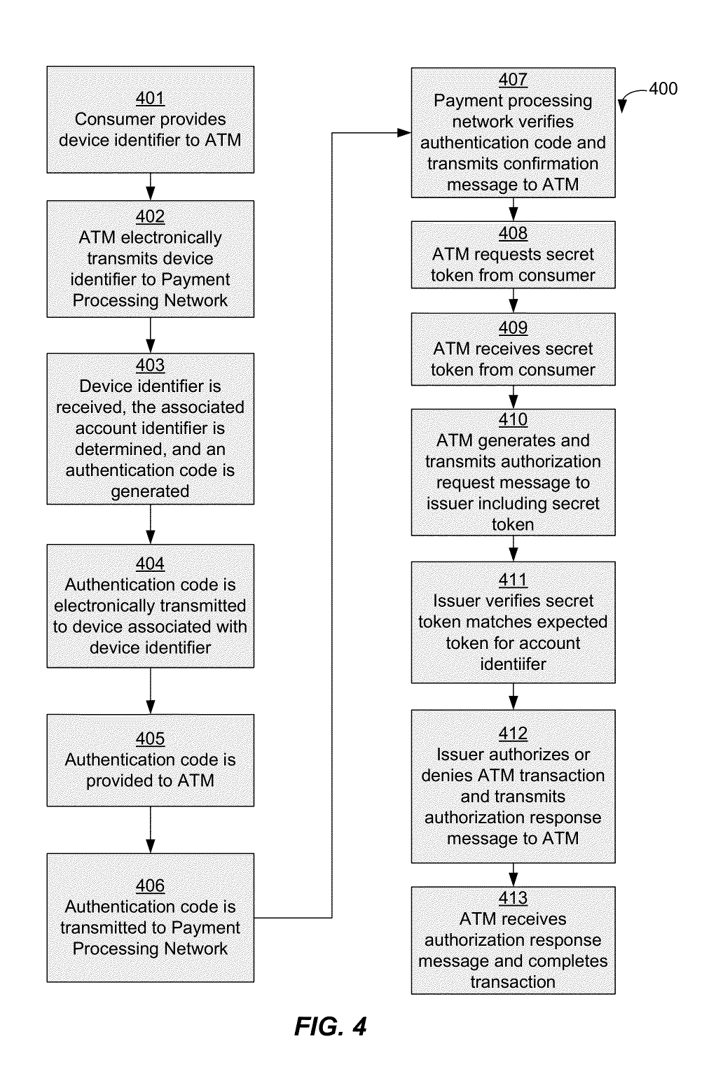

An authentication code generator module 304 in the computer readable medium 300(b) may determine an authentication code according to embodiments of the invention, as shown in step 403 of FIGS. 3 and 4. The authentication code generator module may determine an authentication code using a lookup table, a random generator, a pre-determined algorithm, or in any other suitable manner.

The notifications module 302 may form notification and alert messages to transmit the authentication code (step 403 in FIGS. 3 and 4), confirmation messages for validating the received authentication code and providing a corresponding account identifier, rejection of an invalid authentication code, or other notifications to the consumer 102, device 104, ATM 116(a), or ATM operator 116, as shown in steps 404 and 407 of FIGS. 3 and 4.

The payment processing network 110 may also comprise hardware, including a transaction gateway interface 301 to electronically communicate with the ATM operator 116 and ATM 116(a) to verify the account with the device identifier, for example. Additionally, in some embodiments, the transaction gateway interface 301 may be used to communicate with a mobile payment processor 110(a) and/or mobile network operator 130.

The payment processing network 110 may also comprise a network interface 306 to communicate and transmit data to the device 104. The network interface 301 may comprise an antenna, transmitter, receiver, or any other electronic hardware means to electronically communicate to the device 104. Any suitable communications network may be used in embodiments of the present invention and the network interface 301 may be configured to allow the payment processing network 110 to communicate through any suitable communications network.

### II. Exemplary Methods

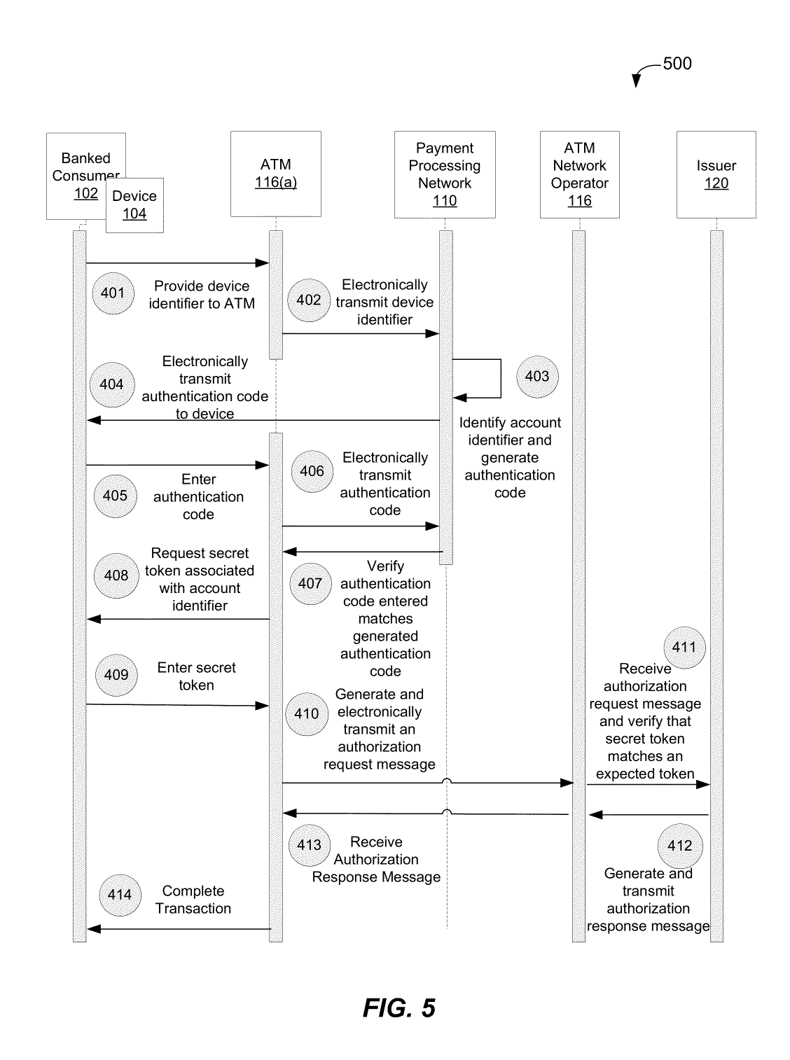

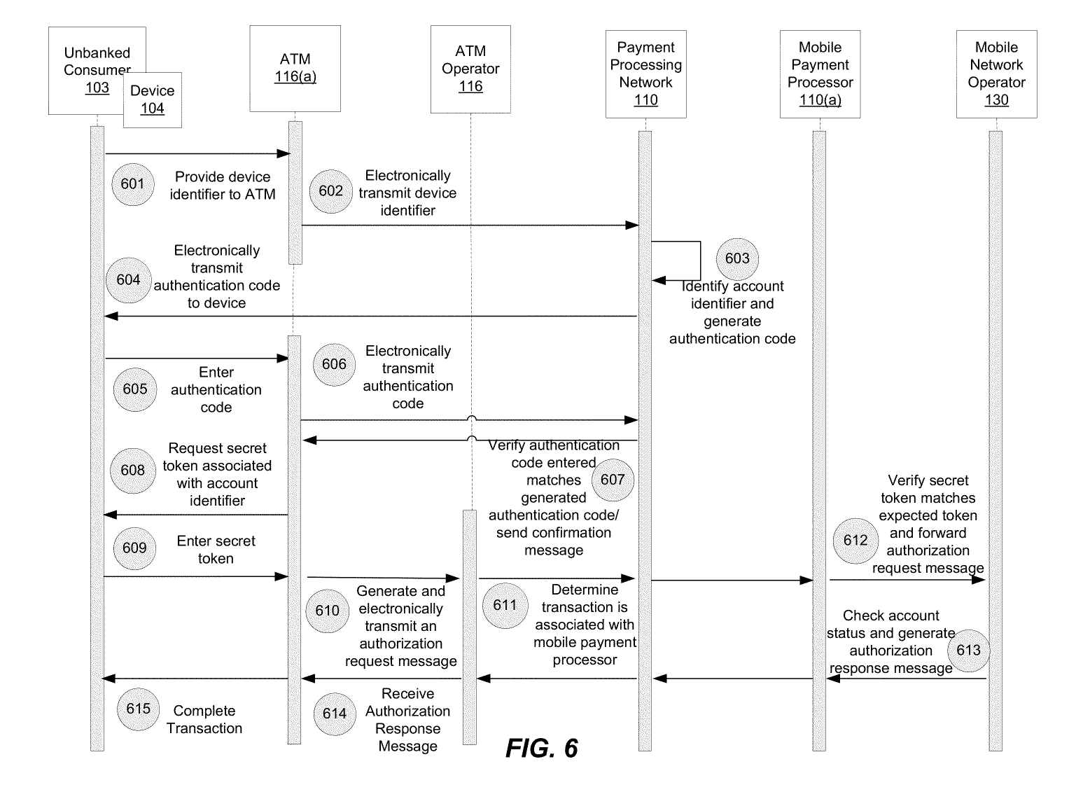

Embodiments of the present invention provide consumers access to transaction apparatuses without the need for physical payment devices or cards associated with a particular account. Embodiments of the present invention may be directed to both banked consumers and unbanked consumers. While both embodiments use authentication codes to authenticate consumers prior to allowing a transaction, the processing of the transactions may be different as different entities are involved in the transaction processing. Accordingly, the different embodiments are shown in different flow diagrams. FIGS. 4 and 5 are directed to methods of completing transactions with transaction apparatuses where the consumer is banked but does not have a physical card linked to the banked account in their possession. Alternatively, FIG. 6 is directed to a method of performing a transaction with a transaction apparatus where the consumer is unbanked and thus, does not have a linked card or portable consumer device to an issuer system 120.

Embodiments of the present invention are not limited to ATM transactions although examples provided herein focus on such embodiments. Accordingly, some embodiments of the present invention may be used in any suitable transactions. For example, embodiments may be used to complete airtime purchases (e.g. buying pre-paid minutes for a mobile telephone or pre-paid long distance minutes), purchasing goods from vending machines, etc.

### ATM Transactions for Banked Consumers

An exemplary flowchart 400 of a method according to an embodiment of the invention is shown in FIG. 4. For example, the method of FIG. 4 illustrates how a banked consumer may perform a transaction with an ATM 116(a) to withdraw cash without the use of a physical card tied to an account. FIG. 5 shows a block diagram of a system implementing the method shown in FIG. 4 and the steps described in FIG. 4 correspond to the method steps shown in the system and method diagram of FIG. 5.

In step 401, the banked consumer 102 provides a device identifier to the ATM 116(a). The consumer 102 may have a mobile device 104, and may be asked to provide a device identifier to an ATM 116(a) to initiate a transaction. For example, the ATM 116(a) may have a display screen saying, “To begin, please insert your ATM card or enter your mobile device number.” The consumer may provide the device identifier in any suitable manner. For example, the consumer 102 may manually enter the device identifier, or in other embodiments, the device 104 may communicate with the ATM 116(a) via Bluetooth, NFC, or other wireless means, such as tapping the device 104 against a receiver on the ATM 116(a).

In step 402, the ATM 116(a) electronically transmits the device identifier to the payment processing network 110. The ATM 116(a) may electronically transmit the device identifier through any suitable manner. For example, the ATM 116(a) may send a mobile device identifier message to the payment processing network 110 including a mobile device identifier for a transaction. The ATM 116(a) may include any other suitable information in the message (e.g. time, location, transaction amount, type of transaction, etc.) or may send the mobile device identifier without any additional information. The ATM 116(a) may ask a consumer to indicate the type of transaction, transaction amount, etc. prior to sending the device identifier or may authenticate the consumer using the authentication code prior to receiving any transaction information in order to limit unnecessary or fraudulent transactions on the ATM 116(a) by filtering fraudulent transactions before receiving transaction details. Either way, the ATM 116(a) generates a message or other data stream and sends the mobile device identifier to a payment processing network 110 or other designated third party. The ATM 116(a) may include a database that determines which payment processing network 110 to send the message to based on the mobile device identifier, or the consumer may inform the ATM 116(a) which payment processing network 110 their device 104 is associated with. Alternatively, the ATM may forward the query to the ATM operator, and the ATM operator may determine where to send the authentication request message. Additionally, the device identifier may comprise information that immediately indicates which payment processing network 110 to route the device identifier to.

In step 403, the payment processing network 110 receives the mobile device identifier from the ATM 116(a), determines an account identifier associated with the device identifier, and generates an authentication code associated with the mobile device identifier and/or account identifier. The authentication code may be pre-determined and static or may be dynamic. Additionally, the authentication code may be associated with or based on the mobile device identifier and/or account identifier, or may be randomly generated. For example, the authentication code may be generated using an algorithm with a random input or may be based on information contained in the mobile device identifier (e.g. the first three digits of the mobile device identifier may be used in the authentication code). The authentication code may be recognizable. For example, the authentication code may be based on known words, names, places, etc. or may be based on collection of such information or may be random collections of numbers, letters, and symbols.

For example, a payment processing network may receive a request to generate an authentication code for a mobile device identifier of 415-777-7777. A routing directory module 308 at the payment processing network may search the device database 303 and/or account database to determine that the device identifier is associated with a corresponding account identifier of 4444-4512-1352-1111. The payment processing network may then generate an authentication code using the authentication code generator module 304 and store the authentication code in either the account database 305 or the device database 303, or in a separate authentication code database (not shown in FIG. 3). The authentication code may be generated at random, for example, the payment processing network may generate an authentication code of 1111 for the transaction. The payment processing network may also only store the authentication code for a set amount of time (thereby automatically deleting it after a pre-determined period of time (e.g. thirty minutes)) or may keep a log of the authentication code and the time the authentication code was generated. In the later embodiment, the authentication code verification module 307 of the payment processing network may send a negative indication of authentication if an authentication request message is received for a transaction that is initiated after the effective time period has lapsed for an authentication code. Furthermore, only one authentication code for a mobile device identifier may be active at any given time. If a new authentication code is generated, the old one may be replaced. Additionally, the authentication code may expire after if the authentication code is entered incorrectly three times during an attempted transaction.

In step 404, the payment processing network 110 electronically transmits the authentication code to the device 104. The authentication code may be electronically transmitted through any suitable method. The payment processing network 110 may comprise hardware such as a network interface 301 to communicate and transmit data to the device 104. The network interface 301 may comprise an antenna, transmitter, receiver, or any other electronic hardware means to electronically communicate to the device 104. For example, the notifications module 302 of the payment processing network 110 may send the authentication code to the mobile device 104 through a network interface 112 to a communications network. Any suitable communications network may be implemented in embodiments of the present invention. The communications network may be operated by a mobile network operator 130 and may provide communications with the mobile device 104. For example, the network interface 301 may be configured to communicate with a cellular network and send the authentication code as a short message service (SMS) message. Alternatively, the notifications module of the payment processing network 110 may transmit the authentication code via an email, via a telephone call, or through any other suitable electronic transmission method.

Additionally, when the authentication code is transmitted to the mobile device 104, additional text in the message may indicate the minimum and maximum transaction amounts that the ATM 116(a) can dispense for the consumer's information purposes. This may promote faster ATM usage times for consumers because they may know their transaction limits before attempting a transaction that may be over the limit.

In step 405, the consumer enters the authentication code received on the mobile device 104 into the ATM 116(a). The consumer may enter the authentication code through any suitable method. For example, the consumer may manually enter the authentication code received in the SMS message using a keyboard or touch screen of the ATM 116(a). Using the example above, the consumer may receive the text message comprising the authentication code 1111 and may enter the 1111 into the ATM. Alternatively, the authentication code could be transmitted via a short range communications element, another SMS message to the ATM 116(a), or through any other suitable method.

In step 406, the ATM 116(a) electronically transmits a query including the authentication code to the payment processing network 110 for verification. An authentication code verification module 307 at the payment processing network 110 verifies that the authentication code entered by the consumer 102 matches the previously generated authentication code sent to the device 104 and stored in the account database 305 or device database 303.

In step 407, the authentication code verification module 307 at the payment processing network verifies that the received authentication code matches the generated authentication code and transmits a confirmation message back to the ATM. The notifications module at the payment processing network 110 may electronically transmit a confirmation message to the ATM 116(a) that the authentication code is verified. The confirmation message may include an indication that the authentication code is verified and may also include the account identifier corresponding to the mobile device identifier. The confirmation message may comprise a flag informing the ATM 116(a) that the consumer is authenticated, a message such as, for example, “authenticated” or “not authenticated,” or the confirmation message may provide an account identifier, mobile device identifier, name of the consumer, or any other information to inform the ATM that the consumer has been authenticated. For instance, using the example above, if the payment processing network receives an authentication code of 1111 from the ATM within the time limit set for the authentication code, the payment processing network may generate a confirmation message including the account identifier (4444-4512-1352-1111), the mobile device identifier (415-777-7777), a message stating “Jon Doe is authenticated,” or a message comprising a flag indicating authentication.

In step 408, the ATM 116(a) receives the confirmation message from the payment processing network 110 including an indication that the authentication code is verified. Therefore, the payment processing network 110 is confirming the consumer 102 is in possession of the device 104 associated with the account identifier. Once the entered authentication code is verified as matching the generated authentication code, the consumer 102 can continue the transaction similarly to a typical ATM transaction. The ATM 116(a) may request the consumer 102 to enter a secret token that is pre-determined and associated with the account identifier, as in a typical ATM transaction. Therefore, the ATM 116(a) may now verify that the consumer is an authorized consumer of the account associated with the mobile device 104 by submitting an authorization request message comprising the secret token to be verified by an issuer system 120.

Accordingly, in step 409, the consumer may then enter a secret token that matches an expected token determined during registration or creation of the account. The consumer 102 may manually enter the secret token into the ATM 116(a) via a keypad or touchscreen or may enter the secret token through any other suitable input.

In step 410, the ATM generates and transmits an authorization request message to the issuer associated with the account identifier. The authorization request message may be routed through an ATM operator which may determine where to send the authorization request message based on the account identifier or other information included in the authorization request message. The authorization request message may include an issuer account identifier that may be associated with a payment device or payment account and a secret token provided by a consumer. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, ATM identifier, ATM location, etc., as well as any other information that may be utilized in determining whether to identify and/or authorize a transaction.

In step 411, the issuer system 120 receives the authorization request message and verifies that the secret token entered is associated with the account identifier. This is similar to typical ATM transaction systems that are currently in place. The issuer system 120 may determine an expected token associated with the account identifier received in the authorization request message and may compare the received secret token in the authorization request message to the expected token. The expected token may be determined and stored in the account database of the issuer system 120 during registration or opening of the account and may be provided by the consumer 102 or the issuer system 120. If the secret token matches the expected token, the issuer may verify the consumer as being authorized to use the account. The issuer system 120 may then determine whether the account has sufficient funds for the transaction or may investigate the account for other reasons not to authorize the transaction (e.g. the account is delinquent, etc.), and may determine the transaction request may be authorized or denied.

In step 412, if the secret token is verified and the account has sufficient funds, then the transaction may be authorized, and the issuer system 120 may electronically transmit an authorization response message to the ATM 116(a) that the transaction is authorized.

In step 413, the ATM 116(a) receives the authorization response message including verification that the secret token is verified and authorization to complete the transaction. The ATM 116(a) may then complete the transaction by dispensing the authorized transaction value to the consumer in cash, or in the case of a vending machine, may provide a desired object to the consumer. After receiving the authorization response message and receiving verification that the secret token matches the expected token, the ATM 116(a) may complete the transaction as requested by the consumer and may allow the consumer to initiate a new transaction (withdraw cash, balance inquiry, etc.).

### ATM Transactions for Unbanked Consumers

In another embodiment of the invention, methods and systems for providing unbanked consumers 103 with access to funds at transaction apparatuses may be implemented. For example, a payment processing network 110 and mobile payment processor 110(a) 110(a) may facilitate transactions between ATM operators 116 and mobile network operators 130 (e.g. cellular phone companies) or other service providers for unbanked consumers 103. These transactions may be implemented without the need for physical cards or other portable consumer devices.

FIG. 6 illustrates an exemplary method for a cash withdrawal at an ATM 116(a) for an unbanked consumer 103 according to embodiments of the invention. The method may involve an unbanked consumer 103, a device 104, an ATM 116(a), an ATM operator 116, a payment processing network 110, a mobile payment processor 110(a) 110(a), and a mobile network operator 130.

In step 601, the unbanked consumer 103 may choose a card-less transaction at an ATM 116(a). Similar to the method described above in reference to FIGS. 4 and 5, the consumer 103 may enter a device identifier which may be routed to a payment processing network 110 to generate an authentication code. The payment processing network 110 may then determine the associated account identifier and generate an authentication code. The payment processing network 110 may then transmit the authentication code to the mobile device 104 associated with the mobile device identifier. Furthermore, in some embodiments the consumer 103 may request the authentication code directly from the payment processing network 110 and may enter the authentication code at the ATM 116(a) instead of, or in addition to, a mobile device identifier.

Steps 601-609 of FIG. 6 may be the same functionally whether the consumer is banked or unbanked. Accordingly, the description above regarding FIGS. 4 and 5 describe these steps in detail and the same description applies for the unbanked consumer 103 embodiment. Accordingly, paragraphs corresponding to steps 401-409 described above may be referenced for further description of these steps.

At step 610, after the ATM 116(a) has received the secret token from the consumer, the ATM 116(a) may generate and electronically transmit an authorization request message to a corresponding ATM operator 116 (e.g. bank, ATM network, etc.). The authorization request message may comprise the secret token, the device identifier, and/or an account identifier if the unbanked consumer 103 has such an account identifier registered with the payment processing network.

In step 611, the ATM operator 116 (or the ATM 116(a)) may determine that the transaction is associated with a mobile payment processor 110(a) and the authorization request message may be forwarded to a payment processing network 110 associated with the account identifier or mobile device identifier included in the authorization request message. The ATM operator 116 may route the request to a mobile payment processor 110(a) based on an identifier in the authorization request message. The authorization request message may be sent from the ATM operator 116 to the mobile payment processor 110(a). The mobile payment processor 110(a) may be included as a part of a payment processing network 110 or may be coupled to the payment processing network 110 in order to be easily incorporated into transaction systems and as such, the ATM operator 116 or ATM 116(a) may forward the authorization request message to the payment processing network 110, which may then subsequently forward the authentication request message to the mobile payment processor 110(a).

At step 612, the mobile payment processor 110(a) may receive and translate the authorization request message from the payment processing network 110 and may verify that the secret token included in the authorization request message matches an expected token associated with the account identifier or mobile device identifier included in the authorization request message. The mobile payment processor 110(a) may verify the secret token matches the expected token by receiving the authorization request message, determining an expected token for the account identifier or mobile device identifier included in the authorization request message, and comparing the received secret token and the expected token. Accordingly, the mobile payment processor 110(a) may decrypt and validate the secret token as matching the expected token associated with the mobile device identifier and/or account identifier associated with the mobile network operator 130. Thereafter, the mobile payment processor 110(a) may determine the corresponding mobile network operator 130 and route the authorization request message to the appropriate mobile network operator 130. Accordingly, the mobile payment processor 110(a) may have access to the account database and device databases shown in FIG. 3 corresponding to the payment processing network 110 as well as having access to an expected token database or the account database may comprise expected token information for the accounts.

At step 613, the mobile network operator 130 verifies that the consumer account is current, is not delinquent, or otherwise verifies that the account is not in a state where the mobile network operator 130 believes they may not be paid and authorizes the transaction. The mobile network operator 130 may authorize the transaction by generating and transmitting an authorization response message back to the mobile payment processor 110(a). Accordingly, the mobile payment processor 110(a) may receive the authorization response message from the mobile network operator 130. In some embodiments, the mobile payment processor 110(a) may log the response from the mobile network operator 130 and may perform protocol translations of information included therein to generate a proper authorization response message to return to the payment processing network 110 (not shown). Accordingly, the mobile payment processor 110(a) may accomplish any necessary steps to ease the transaction processing of the mobile network operator 130.

Additionally, in some embodiments, the mobile payment processor 110(a) may receive, interpret, and process the authorization request message sent from the payment processing network 110 and may be the processing end point for the transaction (not shown). In such embodiments, the mobile payment processor 110(a) may complete the authorization of the transaction for the mobile network operator 130 that does not have the infrastructure or capability of determining an account status and generating an authorization response message at the time of the transaction. This embodiment may be implemented in any suitable manner, as one of ordinary skill in the art would recognize. For example, the mobile payment processor 110(a) may access a database of current and delinquent accounts for the mobile network operator 130 and may check to determine if an account is current before authorizing a transaction. The mobile payment processor 110(a) may also determine the transaction amount and may validate the amount with the mobile network operator 130. The mobile payment processor 110(a) may then debit the account and create a credit ATM settlement ledger. An authorization response message may be generated and sent to the ATM operator 116. Accordingly, in some embodiments, the mobile network operator 130 may only participate in the clearance and settlement of the transaction by paying the ATM operator 116 but may not engage in the transaction processing in a significant manner otherwise.

However, in the embodiment shown in FIG. 6, at step 613, the mobile network operator 130 generates the authorization response message and forwards the authorization response message to the mobile payment processor 110(a) to be forwarded to the payment processing network 110, the ATM operator 116, and subsequently the ATM 116(a).

In step 614, the ATM operator 116 receives the authorization response message and routes the authorization response message back to the source ATM 116(a). The ATM 116(a) receives the authorization response message, determines whether the transaction is authorized, denied, or other action items exist (e.g. asking for further information), and then completes the transaction. The ATM may complete the transaction by distributing a transaction amount in cash or, in embodiments where the transaction apparatus is a vending machine, the vending machine may distribute an object to the unbanked consumer 103.

A clearance and settlement process may be implemented whereby the ATM operator 116 sends a file containing all relevant ATM transactions for a given period to the mobile payment processor 110(a) or mobile network operator 130. The mobile payment processor 110(a) may provide an automatic reconciliation module (ARM) which may compare the ATM operator 116 file with a list of mobile payment processor 110(a) transactions for the same period. Matching transactions may be “marked off” and included in the calculation of the net settlement position. Discrepancies determined by either the mobile payment processor 110(a) or the ATM operator 116 may be highlighted and reports may be generated for manual investigation and correction. The report may also contain the net settlement amount. The net settlement amount as determined by the reconciliation process may be used to balance the mobile payment processor 110(a) ledger accounts by transferring funds from the mobile network operator 130 to the ATM operator network.

### III. Other Exemplary Embodiments

In another embodiment of the present invention, a consumer may go to an ATM 116(a) to initiate a deposit without a card. The consumer may enter their mobile number on the ATM screen, the ATM operator 116 may send an authorization request to the consumer's mobile phone and the consumer may select the account and enter the authorization code into the ATM 116(a). The payment processing network 110 may authenticate the consumer using the authentication code and may send a confirmation message including an indication of the confirmation or rejection of the authentication code to the ATM 116(a). The payment processing network 110 may also determine an account identifier associated with the mobile device identifier and include the account identifier in the confirmation message. The consumer may enter the amount and their account identifier secret token on the ATM screen and may initiate an ATM transaction. The ATM operator 116 may route the transaction to the issuing processor and/or mobile payment processor 110(a) based on the account identifier, device identifier, or any other information included in the authorization request message. The mobile payment processor 110(a) may resolve and verify the destination account and mobile network operator 130 associated with the account. The mobile payment processor 110(a) may debit the settlement account and credit the consumer account. The mobile payment processor 110(a) may initiate a confirmation/denial message by generating an authorization response message and transmitting the message to the ATM operator 116. The mobile payment processor 110(a) creates a settlement entry between the ATM operator 116 and the mobile network operator 130. The mobile payment processor 110(a) may then notify the consumer of the successful completion of the transaction and their change in balance.

In another embodiment, the consumer may select an “ATM cash withdrawal” on their mobile phone and enter a secret token and cash out amount (optional). The mobile payment processor 110(a) may then send a one-time account identifier instead of the authentication code for ATM cash withdrawal and their available balance to consumer's mobile phone number. The consumer may then use the one-time account identifier (i.e. authentication code) at an ATM 116(a) to initiate a withdrawal. The consumer may enter the amount and their secret token. The ATM operator 116 or payment processing network 110 may then route the transaction to the mobile payment processor 110(a) based on the one-time account identifier (i.e. authentication code). The mobile payment processor 110(a) may debit the corresponding consumer account and may credit the settlement account for settlement. The mobile payment processor 110(a) may generate an authorization response message including a confirmation/denial message and transmit the authorization response message to the ATM operator 116 and the ATM 116(a). The ATM 116(a) may then disburse the transaction amount to the consumer. The mobile payment processor 110(a) may notify the consumer of the successful completion of the transaction and their change in balance by sending a notification to the consumer's device 104 that was used to initiate the transaction. Finally, the ATM operator 116 or payment processing network 110 creates a settlement entry between the ATM processor and mobile network operator 130.

### IV. Technical Advantages

Embodiments of the invention have many technical advantages. According to embodiments of the invention, a consumer need not carry a portable consumer device (e.g., ATM card) associated with the consumer's account (e.g. PAN) to conduct transactions at an ATM. The consumer's account may be identified by a device in possession of the consumer, by transmitting the device identifier to a payment processing network via the ATM, determining an associated account with the device identifier, generating a dynamic authentication code, transmitting the authentication code to the device identifier, and entering the authentication code received by the device into the ATM. Reducing the number of portable consumer devices that need to be carried provides convenience and also reduces the risk of loss or theft. Accordingly, embodiments of the present invention lower the risk of fraudulent transactions by limiting the amount of stolen or found portable consumer devices that may be used to initiate a transaction.

When the authentication code is verified by the ATM communicating with the payment processing network, confirming that the authentication code entered by the consumer matches the authentication code generated by the payment processing network for the associated account, the system performs a separate verification of a consumer's identity. Accordingly, only consumers who have access to the mobile device that is associated with the account identifier may initiate a transaction as they need to enter an authorization code sent to the mobile device to generate an authorization request message. Accordingly, a consumer can only continue the transaction on the ATM if they have access to the mobile device associated with the mobile device identifier entered into the transaction apparatus. Once authenticated, a second layer of authentication may be implemented such that the consumer may enter a secret token associated with the account identifier or mobile device identifier. Accordingly, the consumer may be verified by two separate systems in order to gain access to the account without having to use or have possession of the ATM card. The use of two separate verification systems is advantageous because it lowers the possibility that a single system's security could be bypassed.

Determining a dynamic authentication code transmitted to the device adds another layer of security in the authentication process. Typical secret tokens are four digits and are static in that they are pre-determined by either the consumer or the ATM operator (e.g., issuing bank). Thus the secret token may be vulnerable to fraud or malicious probing. However, the authentication code is dynamic in that it is unique to every transaction and generated at the time of the transaction when the device identifier is transmitted to the payment processing network and the associated account identified. Thus it is less likely for the authentication code to be comprised. Additionally, the authentication code may be random and may not be duplicated by a malicious third party.

Furthermore, if the device of the consumer were stolen by an invalid consumer, the invalid consumer would still need the secret token to fully access the account and conduct transactions using the account. Therefore it would be difficult for fraudulent activity to occur because an invalid consumer would need to acquire the device of the valid consumer as well as the valid consumer's secret token.

Additionally, embodiments directed to providing unbanked consumers the ability to perform transactions with transaction apparatuses provides multiple advantages. For example, the mobile payment processor provides a switch for routing and facilitating transactions between ATM operators and mobile network operators. Providing a switch between mobile network operators and ATM operators provides advantages for mobile network operators that do not have the facilities to perform transaction routing and authorizations.

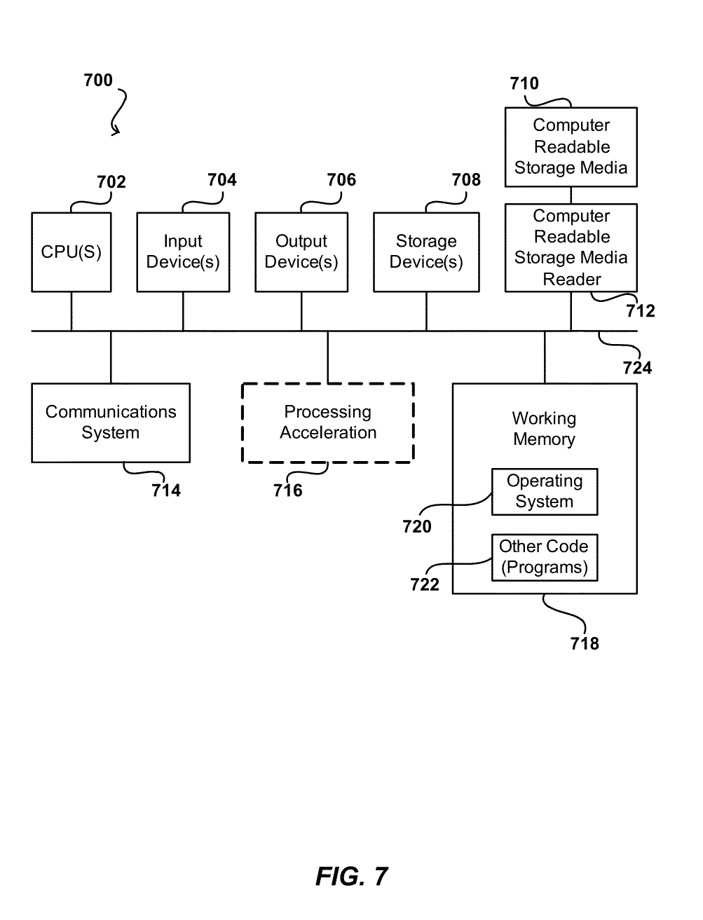

The ATM 116(a), ATM operator 116, payment processing network 110, mobile payment processor 110(a), issuer 120, or mobile network operator 130 may utilize any suitable number of subsystems or hardware and software components. Examples of such subsystems or components are shown in FIG. 7. FIG. 7 shows an exemplary computer apparatus according to embodiments of the invention, in which various embodiments may be implemented. The system 700 may be used to implement any of the computer systems described above (e.g., client computer, a server computer at the payment processing network, a computer apparatus at the issuer, etc.). The computer system 700 is shown comprising hardware elements that may be electrically coupled via a bus 724. The hardware elements may include one or more central processing units (CPUs) 702, one or more input devices 704 (e.g., a mouse, a keyboard, etc.), and one or more output devices 706 (e.g., a display device, a printer, etc.). The computer system 700 may also include one or more storage devices 708. By way of example, the storage device(s) 708 can include devices such as disk drives, optical storage devices, solid-state storage device such as a random access memory (“RAM”) and/or a read-only memory (“ROM”), which can be programmable, flash-updateable and/or the like.

The computer system 700 may additionally include a computer-readable storage media reader 712, a communications system 714 (e.g., a modem, a network card (wireless or wired), an infra-red communication device, etc.), and working memory 718, which may include RAM and ROM devices as described above. In some embodiments, the computer system 700 may also include a processing acceleration unit 716, which can include a digital signal processor DSP, a special-purpose processor, and/or the like.

The computer-readable storage media reader 712 can further be connected to a computer-readable storage medium 710, together (and, optionally, in combination with storage device(s) 708) comprehensively representing remote, local, fixed, and/or removable storage devices plus storage media for temporarily and/or more permanently containing, storing, transmitting, and retrieving computer-readable information. The communications system 714 may permit data to be exchanged with the network and/or any other computer described above with respect to the system 700.

The computer system 700 may also comprise software elements, shown as being currently located within a working memory 718, including an operating system 720 and/or other code 722, such as an application program (which may be a client application, Web browser, mid-tier application, RDBMS, etc.). It should be appreciated that alternate embodiments of a computer system 700 may have numerous variations from that described above. For example, customized hardware might also be used and/or particular elements might be implemented in hardware, software (including portable software, such as applets), or both. Further, connection to other computing devices such as network input/output devices may be employed.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A transaction apparatus comprising:
a processor; and
a computer-readable storage medium, comprising code executable by the processor to implement a method, the method comprising:
receiving an authentication code from a consumer;
sending the authentication code to a first server computer, wherein if the received authentication code matches a generated authentication code, the first server sends a confirmation message;
receiving the confirmation message;
receiving a secret token from the consumer;
sending an authorization request message to a second server computer; and
receiving an authorization response message from the second server computer, wherein the authorization response message indicates that the secret token matches an expected token.

2. The transaction apparatus of claim 1 wherein the method further comprises before receiving the authentication code from the consumer, electronically receiving a device identifier and sending the device identifier to the first server computer.

3. The transaction apparatus of claim 1 wherein the authentication code is a dynamic code generated by the first server computer.

4. The transaction apparatus of claim 1 wherein the confirmation message comprises an account identifier, wherein the second server computer is associated with the account identifier, wherein the authorization request message comprises the secret token and the account identifier, and wherein the second server computer determines the expected token associated with the account identifier and compares the expected token to the secret token, and wherein the authorization response message indicates whether the transaction is authorized.

5. The transaction apparatus of claim 1 further comprising completing a transaction, wherein completing a transaction further comprises dispensing the transaction amount in cash to the consumer.

6. The transaction apparatus of claim 1 further comprising completing a transaction, wherein completing a transaction comprises dispensing an object to the consumer.

7. A method comprising:
receiving an authentication code from a consumer;
sending the authentication code to a first server computer, wherein if the received authentication code matches a generated authentication code, the first server sends a confirmation message;
receiving the confirmation message;
receiving a secret token from the consumer;
sending an authorization request message to a second server computer; and
receiving an authorization response message from the second server computer, wherein the authorization response message indicates that the secret token matches an expected token.

8. The method of claim 7 further comprising before receiving an authentication code from the consumer, electronically receiving a device identifier and sending the device identifier to the first server computer.

9. The method of claim 7 wherein the authentication code is a dynamic code generated by the first server computer.

10. The method of claim 7 wherein the confirmation message comprises an account identifier, wherein the second server computer is associated with the account identifier, wherein the authorization request message comprises the secret token and the account identifier, and wherein the second server computer determines the expected token associated with the account identifier and compares the expected token to the secret token, and wherein the authorization response message indicates whether the transaction is authorized.

11. The method of claim 7 further comprising completing a transaction, wherein completing a transaction further comprises dispensing the transaction amount in cash to the consumer.

12. The method of claim 7 further comprising completing a transaction, wherein completing a transaction comprises dispensing an object to the consumer.

13. A first server computer comprising:
a processor; and
a computer-readable storage medium, comprising code executable by the processor to implement a method, the method comprising:
electronically receiving a device identifier;
generating an authentication code for a transaction;
electronically transmitting the generated authentication code to a device associated with the device identifier;
electronically receiving, from a transaction apparatus, a received authentication code;
matching the received authentication code with the generated authentication code for the transaction; and
sending a confirmation message to the transaction apparatus, wherein the transaction apparatus sends an authorization request message to a second server computer and receives an authorization response message from the second server computer.

14. The first server computer of claim 13 wherein the authentication code for the transaction is a dynamic code.

15. The first server computer of claim 13 wherein the device identifier is received from the transaction apparatus.

16. The first server computer of claim 13 wherein the device identifier is received from a consumer device.

17. The first server computer of claim 13 further comprising searching a database for an account identifier associated with the device identifier, wherein the confirmation message comprises the account identifier, wherein the second server computer is associated with the account identifier, and wherein the authorization response message indicates whether the transaction is authorized.

18. A method comprising:
electronically receiving, at a first server computer, a device identifier;
generating an authentication code for a transaction,
electronically transmitting the generated authentication code to a device associated with the device identifier,
electronically receiving, from a transaction apparatus, a received authentication code;
matching the received authentication code with the generated authentication code for the transaction, and
sending a confirmation message to the transaction apparatus, wherein the transaction apparatus sends an authorization request message to a second server computer and receives an authorization response message from the second server computer.

19. The method of claim 18 wherein the authentication code for the transaction is a dynamic code.

20. The method of claim 18 wherein the device identifier is received from the transaction apparatus.

21. The method of claim 18 wherein the device identifier is received from a consumer device.

22. The method of claim 18 further comprising searching a database for an account identifier associated with the device identifier, wherein the confirmation message comprises the account identifier, wherein the second server computer is associated with the account identifier, and wherein the authorization response message indicates whether the transaction is authorized.
